(19) United States
(12) Patent Application Publication
(10) Pub. No.: US 2026/0319617 A1
(43) Pub. Date: Oct. 15, 2026

(54) BASELINE COMPENSATION FOR A CAPACITIVE TOUCH SENSOR

(71) Applicant: Silicon Laboratories Inc., Austin, TX (US)

(72) Inventor: Bertrand J. Williams, Key Largo, FL (US)

(21) Appl. No.: 19/175,400

(22) Filed: Apr. 10, 2025

(51) Int. Cl. G06F 3/041; G06F 3/044

(52) U.S. Cl. CPC G06F 3/0418; G06F 3/044

(57) ABSTRACT

A capacitive touch sensor compensates for static baseline capacitance to increase an available sensing range for touch detection. The front end of the capacitive touch sensor has a voltage divider formed by a first and a second effective resistance. The first effective resistance is a switched capacitor circuit that includes an off-chip sensor capacitor of the capacitive touch sensor. The second effective resistance is a switched capacitor circuit that uses an on-chip capacitance. A baseline compensation is achieved by adjusting resistance values of the voltage divider until an output of a sigma delta analog to digital converter coupled to the voltage divider is at a desired value to thereby significantly reduce the contribution of the static capacitance to a touch measurement and allow nearly the full range of the sigma delta analog to digital converter to be used for touch sensing.

### CROSS-REFERENCE TO RELATED APPLICATION(S)

This application relates to the application entitled “Sigma Delta Capacitive Touch Sensor”, naming Bertrand J. Williams as inventor, filed the same day as the present application, having docket number 026-0529, application number “xxxxx”, which application is incorporated herein by reference.

### BACKGROUND

### Field of the Invention

This application relates to capacitive touch sensors and increasing the accuracy of sensing a touch.

### Description of the Related Art

Capacitive touch sensors are used, e.g., on cell phones and user interfaces of other devices to allow users to input information. Such capacitive touch sensors typically work by detecting a difference between a measured capacitance value and a baseline value to determine if a touch has occurred. That difference can be very small. The small difference can be harder to measure when the baseline capacitance is high. FIG. 1 illustrates a capacitive touch sensor that includes a sensor pad 102 mounted on a printed circuit board 108 and coupled through a via and a trace 104 to an input/output (I/O) pin 106 of the device that determines if a touch occurred, e.g., a micro controller unit (MCU). The touch sensor further includes an overlay 112 above the ground plane 114.

The capacitance of a parallel plate capacitance is

$$C = \frac{{ε}_{0} {ε}_{r} A}{d} ,$$

where ε₀ is the permittivity of free space, εᵣ represents the relative permittivity of the dielectric material, A is the area of the plate, and d is the distance between the plates. Without a touch being present the baseline capacitance of the capacitive touch sensor is C_{PAD}. When the finger 110 touches the overlay 112 the capacitance becomes C_{PAD}+C_{T}, where C_{T} is the additional capacitance caused by the touch and is small relative to C_{PAD}. For example, a typical C_{PAD} can range from 5 pF-40 pF, while a typical C_{T} can range from 200 fF-20 pF. Thus, the change in capacitance can range, e.g., from ~0.5% to 50%. When a voltage is applied to charge C_{PAD}+C_{T} the voltage on I/O pin 106 changes (compared to a baseline voltage without C_{T}). The sensing goal is to detect the change in capacitance due to a touch as accurately as possible.

### SUMMARY OF EMBODIMENTS OF THE INVENTION

Accordingly, in one embodiment a capacitive touch sensor includes a first effective resistance formed with a sensor capacitance configured in a first switched capacitor circuit. A baseline compensating effective resistance is formed with a compensation capacitance configured in a second switched capacitor circuit. The first effective resistance and the baseline compensating effective resistance form an effective voltage divider. An analog to digital converter is coupled to the effective voltage divider and configured to supply an indication of a capacitance sensed by the capacitive touch sensor.

In another embodiment a method for sensing a capacitance with a capacitive touch sensor includes providing a first effective resistance with a sensor capacitance in a first switched capacitor circuit and providing a baseline compensating effective resistance with a compensation capacitance in a second switched capacitor circuit. The method further includes using the first effective resistance and the baseline compensating effective resistance as an effective voltage divider and supplying an output of the effective voltage divider that is indicative of a sensed capacitance to a sigma delta analog to digital converter.

In another embodiment a method includes generating a desired baseline for a capacitive touch sensor by compensating for static baseline capacitance of the capacitive touch sensor to thereby increase an available sensing range for detecting a touch of the capacitive touch sensor.

Compensating for the static baseline capacitance may further include adjusting resistance values of a voltage divider having a first effective resistance formed with a first switched capacitor circuit using a first capacitor external to an integrated circuit and having second effective resistance formed with a second switched capacitor circuit formed with a capacitor on the integrated circuit, the adjusting continuing until an output of a sigma delta analog to digital converter coupled to the voltage divider is at a desired value.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a capacitance touch sensor used in self-capacitance mode.

FIG. 2 illustrates a high level block diagram of an embodiment of a capacitive touch sensor system that provides baseline compensation.

FIG. 3 illustrates an embodiment that provides water tolerance using a driven shield.

FIG. 4A illustrates a mutual capacitive touch sensor.

FIG. 4B illustrates how a mutual capacitance touch sensor is affected by a touch.

FIG. 4C illustrates a numeric keypad that uses mutual capacitance sensing.

FIG. 5 illustrates an embodiment that utilizes mutual capacitance mode for touch sensing.

FIG. 6 illustrates the front end of the capacitive sensor configured in self-capacitance mode.

FIG. 7 illustrates a resistance model of the front end of a capacitive touch sensor system that includes a baseline voltage divider formed by the two equivalent resistances.

FIG. 8 illustrates a resistance model of the capacitive touch sensor system when a touch occurs.

FIG. 9A illustrates a second order sigma-delta (ΣΔ) analog to digital converter (ADC) that uses a capacitive multiplier circuit in the first stage of the ΣΔ ADC.

FIG. 9B illustrates another embodiment of a second order ΣΔ ADC that uses a capacitive multiplier circuit in the first stage of the ΣΔ ADC.

FIG. 10 illustrates an embodiment of a capacitive multiplier circuit used in the ΣΔ ADC first stage.

FIG. 11 illustrates a high level block diagram of an embodiment of a microcontroller unit (MCU) that incorporates one or more embodiments of a capacitor touch sensor system described herein.

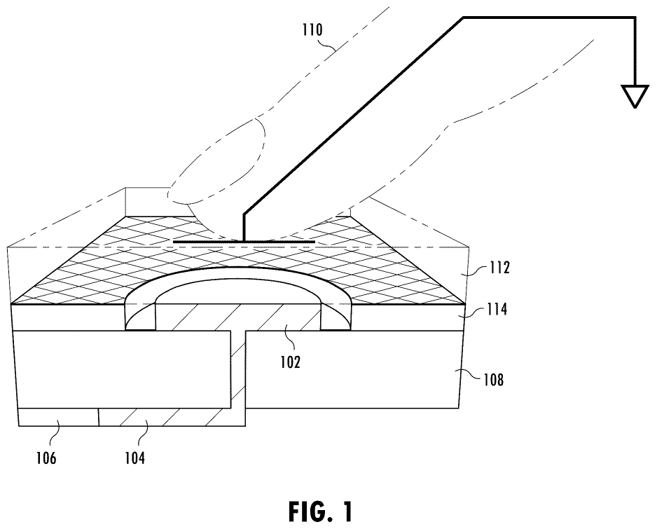

The use of the same reference symbols in different drawings indicates similar or identical items.

### DETAILED DESCRIPTION

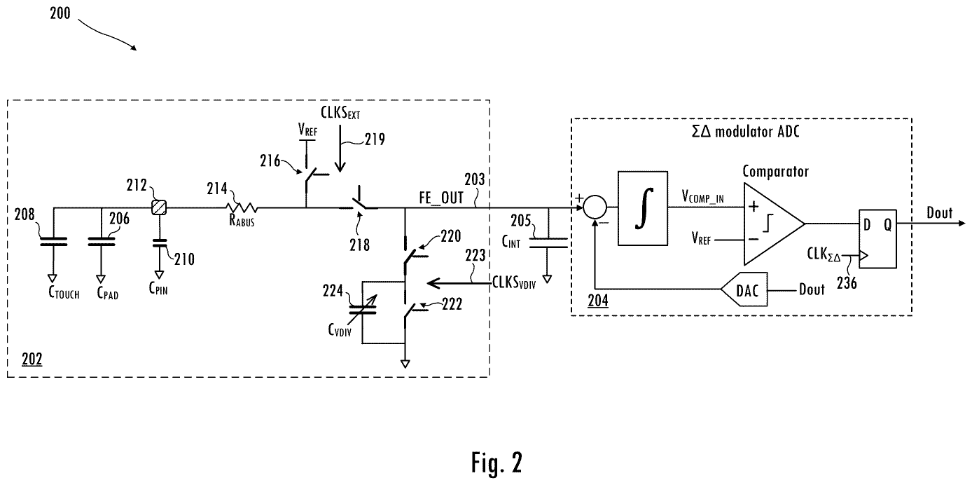

Embodiments herein provide baseline compensation for a capacitive touch sensor that allows a larger portion of the range of the capacitive touch sensor to be used for “touch” detection. To achieve baseline compensation, the system compensates for the static sensor baseline pad capacitance and stray capacitance. FIG. 2 illustrates a high level block diagram of an embodiment of a capacitive touch sensor system 200 that provides baseline compensation. The system includes a switched capacitor voltage divider front end 202 that supplies a front end out signal (FE_OUT) 203 to the ΣΔ ADC 204 and integration capacitor 205 (C_{INT}). The switched capacitor front end illustrated in FIG. 2 is configured for self-capacitance mode in which the capacitance is increased by a touch. The switched capacitor front end 202 includes a capacitor 206 (C_{PAD}) representing the capacitance of the touch pad. The capacitor 208 (C_{TOUCH}) represents the capacitance of the “touch”. A capacitance 210 (C_{PIN}) represents the capacitance of the input/output terminal 212 and other stray capacitance. The resistance 214 (R_{ABUS}) represents the resistance of the analog bus coupled to the external capacitance C_{PAD} and C_{TOUCH}. Switches 216 and 218 function to provide a first switched capacitor circuit formed with C_{PAD}, C_{PIN}, and C_{TOUCH} (when present). Switch 216 allows C_{PAD}, C_{PIN}, and C_{TOUCH} (when a touch is present) to be charged by coupling C_{PAD} to the power supply node VREF. Switch 218 selectively couples C_{PAD}, C_{PIN}, and C_{TOUCH} (when a touch is present) to the ΣΔ ADC 204. Note that although switch 216 is shown in FIG. 2 as being connected to the power supply node (V_{REF}) and switch 222 to the power supply node that is ground, in other embodiments the power supply node connections are switched and switch 216 is connected to ground and switch 222 is connected to (V_{REF}).

Switch 216 is closed when switch 218 is open and vice versa. The switches are controlled by two non-overlapping clock signals having the same frequency and opposite polarity shown as CLKS_{EXT} 219. Typically, a single clock signal of the desired frequency is supplied to a non-overlap circuit that guarantees non-overlap of the clock signals. The switched capacitor circuit formed by switches 216, 218, and C_{PAD} 206 provides a first effective resistance of a voltage divider that provides baseline compensation of the pad capacitance and other stray capacitance to increase the range of the ΣΔ ADC available to sense the touch. Switches 220 and 222 in combination with compensation capacitance 224 (C_{VDIV}) form a second switched capacitor circuit that provides a baseline capacitance equivalent resistance. The switches 220 and 222 are controlled by two non-overlapping clock signals of opposite polarity that have the same frequency shown as CLKS_{VDIV} 223. Switch 220 is closed when switch 222 is open and vice versa. Typically, a single clock signal of the desired frequency is supplied to a non-overlap circuit that guarantees non-overlap of the clock signals. The first equivalent resistance and the baseline capacitance equivalent resistance form a voltage divider that is used to compensate for the baseline and stray capacitance.

In an embodiment, the switches 216, 218, 220 and 222 and the capacitance C_{VDIV} are all on an integrated circuit. The capacitor C_{PAD}, which is much larger than C_{VDIV}, is external the integrated circuit. The equivalent resistance created by a switched capacitor circuit is given by

$$R = \frac{T}{C} ,$$

where T is the period of the clock signals controlling the switches and C is capacitance. To provide a voltage divider with, e.g., equal resistance, the frequency of clock signals CLKS_{VDIV} is much greater than the frequency of the clock signals CLKS_{EXT}. For example, in one embodiment the frequency of the clocks CLKS_{EXT}=125 kHz while the frequency of CLKS_{VDIV}=2 MHz. The period of the CLKS_{EXT} clocks has to be long enough to ensure that the pad capacitance is fully charged when setting the baseline and both the pad capacitance C_{PAD} and the touch capacitance C_{TOUCH} are fully charged when detecting a touch. Of course the frequency of the clock signals can vary according to the needs of the particular implementation. In an embodiment, the frequency of the clock signals CLKS_{EXT} and CLKS_{VDIV} are programmable. In addition, the capacitance C_{VDIV} is also programmable and in embodiments, given the relative ease of capacitance tuning, provides the primary tuning mechanism to set the baseline compensation. The programmability of those parameters (frequency and/or capacitance) allows the equivalent resistance of each part of the voltage divider to be adjusted to a desired level. The output of the ΣΔ ADC is used for configuring the front end to compensate for the baseline capacitance and for sensing the touch as discussed further herein.

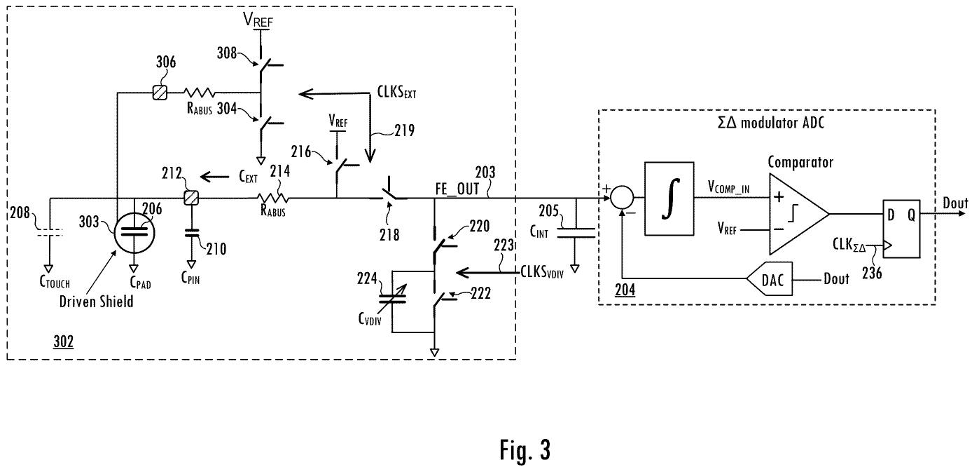

FIG. 3 illustrates an embodiment that provides water tolerance in a switched capacitor voltage divider front end 302 using a driven shield 303. Driven shield mode can be a user selected mode of operation that desensitizes the touch sensor to the presence of moisture. The switches 304 and 308 drive the shield 303 through I/O terminal 306 to provide for water droplet tolerance by equalizing the voltage between C_{PAD} and the shield 303. That helps ensure that moisture is not erroneously interpreted as a touch. The switches 304 and 308 drive the shield in accordance with the clock signals CLKS_{EXT} to provide a waveform to the shield that approximates the signal on the sensor pad C_{PAD}. Thus, switches 308 and 216 are closed (and opened) at the same time and switches 304 and 218 are closed (and opened) at the same time.

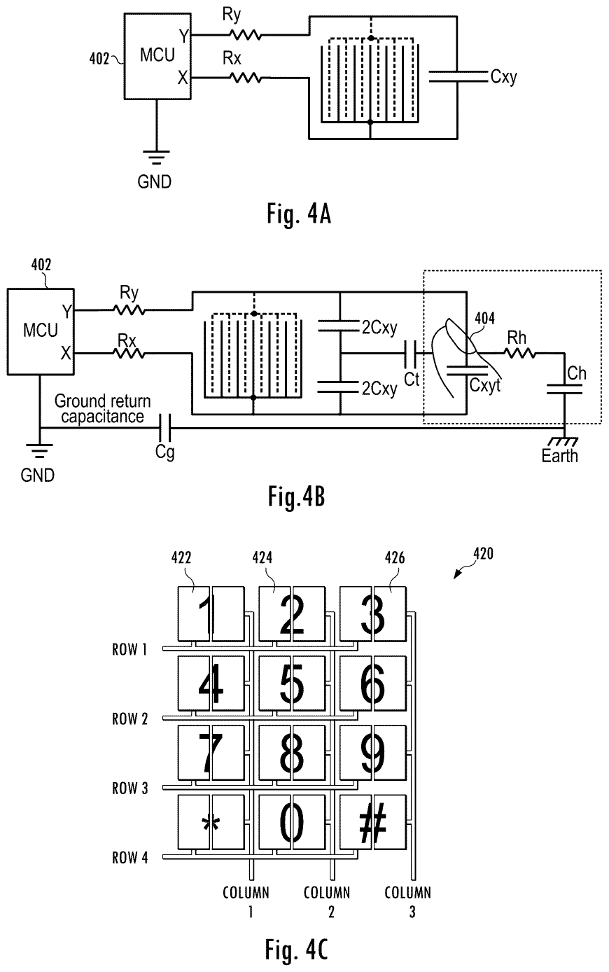

FIGS. 4A-4C illustrate mutual capacitance mode. Referring to FIG. 4A, mutual capacitance touch sensors use an electrode pair for the capacitive sensor and measure the coupling between the electrode pair. MCU 402 has an input (X and Y) for each electrode of the capacitor shown as Cxy. FIG. 4A shows an embodiment in which the capacitance Cxy is formed as a finger capacitor and the sensing senses the coupling between the fingers. FIG. 4B illustrates operation of mutual capacitance mode when a touch occurs. A touch interferes with the electric field between the X and Y electrodes. FIG. 4B illustrates the touch by finger 404. For ease of understanding, the sensor capacitance Cxy is divided into the two series capacitors 2Cxy. The touch capacitance is shown as Ct. The touch from finger 404 results in a third electrode in the XY capacitance and increases the coupling between X and Y, which is modeled by the capacitance Cxyt. The touch capacitance Ct forms a ground return path via Ch (capacitance of human body) and Cg (ground to earth capacitance). The ground return path reduces the amount of charge transferred between the X and Y electrodes, which can cause an apparent decrease in the XY capacitance. Thus, there are circumstances where the desired baseline capacitance is set towards the top of the full-scale detection range.

Mutual capacitance sensing is typically used, e.g., for row and column arrays of touch sensors such as keypads. FIG. 4C illustrates a numeric keypad 420 in which the array of touch pads are identifiable by a row and a column. For example, capacitive touch pads 422, 424, and 426 are coupled to a conductor corresponding to row 1 of pad array 4 and are also coupled to conductors corresponding to column 1, column 2, and column 3, respectively. One plate of touch pad 422 (and the other touch pads) corresponds to the Y electrode and the other plate corresponds to the X electrode. Note that the illustrated numeric keypad 420 has multiple sensors connected to the same sense line, which increases the baseline capacitance making detection accuracy more difficult. Thus, accounting for baseline capacitance prior to sensing is advantageous for mutual capacitance mode embodiments.

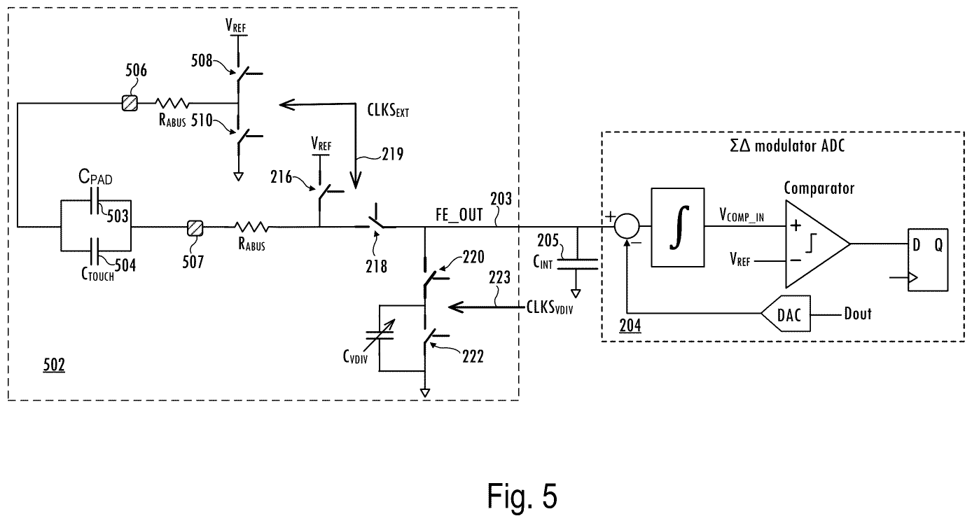

FIG. 5 illustrates an embodiment that utilizes mutual capacitance mode in a switched capacitor voltage divider front end 502. One electrode of C_{PAD} 503 and C_{TOUCH} 504 (when present) are coupled through input/output (I/O) terminal 506 to switches 508 and 510. Switch 508 couples one electrode of C_{PAD} and C_{TOUCH} to the supply voltage V_{REF} and switch 510 couples the other electrode of C_{PAD} and C_{TOUCH} to the ground. Switches 508 and 510 use the same clock signals (CLKS_{EXT} 219) as switches 216 and 218 but are coupled to ensure the switches are 180° out of phase. Thus, when switch 216 is closed, switch 508 is open and switch 510 is closed and when switch 218 is closed switch 510 is open and switch 508 is closed. Switch 216 couples the second electrode of C_{PAD} and C_{TOUCH} to the power supply VREF through I/O terminal 507 when closed and switch 218 couples the second electrode of C_{PAD} and C_{TOUCH} to the ΣΔ modulator 204 and integration capacitor 205 (C_{INT}) when closed. Note that in mutual capacitance mode the resistance R_{ABUS} of the analog bus is twice that of self-capacitance mode and thus the period (T_{EXT}) of CLKS_{EXT} should be extended by two times as well, which either increases potential conversion time for sensing a touch, or decreasing the signal to noise ratio (SNR). In embodiments, the front end can be configured to operate in any of the modes shown as front end 202, 302, and 502.

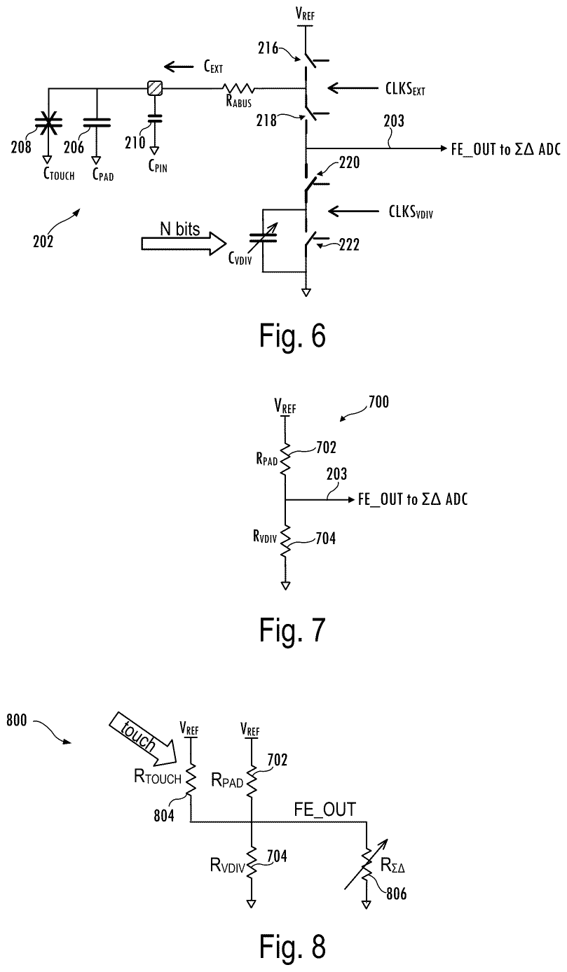

FIG. 6 illustrates the front end 202 of the capacitive sensor configured in self-capacitance mode. During an operation that sets the baseline compensation, the touch capacitor 208 is not present but stray capacitance, e.g., C_{PIN} 210 is present. Thus, setting baseline compensation also accounts for stray capacitance in the system. The capacitance of CDIV may be set, e.g., with an N bit control word, when N is an integer, e.g., 4-8 bits. Similarly, in embodiments the frequencies of CLKS_{VDIV} and CLKS_{EXT} are programmable with multi-bit control words. That allows the baseline compensation to be tuned by adjusting the equivalent resistance of both the switched capacitor circuit that includes C_{PAD} and the switched capacitor circuit that uses C_{VDIV}.

FIG. 7 illustrates the baseline effective voltage divider 700 formed by the two equivalent resistances 702 (R_{PAD}) formed by switched capacitor circuit that includes C_{PAD} and 704 (R_{VDIV}) formed by the switched capacitor circuit that uses C_{VDIV}. The voltage divider 700 supplies its output to the ΣΔ ADC. The values of R_{PAD} and R_{VDIV} are selected to obtain the desired baseline output of the ΣΔ ADC. As explained earlier, the clock frequency and the capacitance values determine the equivalent resistance of a switched capacitor circuit. While the external pad capacitance is typically not tunable, the smaller capacitance on the integrated circuit C_{VDIV} is tunable. In addition, in embodiments the clock frequencies for both equivalent resistances are programmable.

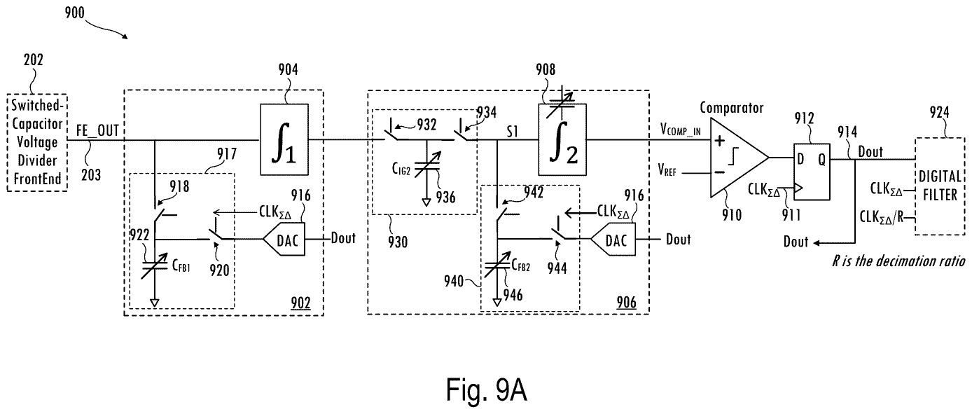

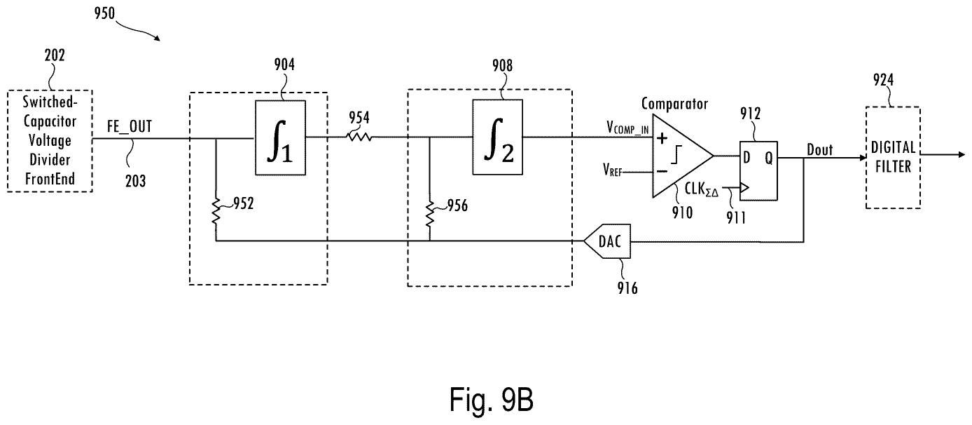

In order to better understand the advantages of baseline compensation, assume the output of the ΣΔ ADC has a 10 bit range (1024) to represent the output of the voltage divider. Without compensation, assume the ΣΔ ADC would provide an output of, e.g., 500 (with a full scale of 1024) as the baseline measurement since the ΣΔ ADC is measuring the large capacitance of the capacitor C_{PAD}. However, by adjusting the voltage divider resistance values, the baseline final output of the ΣΔ ADC can be adjusted to be lower, e.g., 100, to provide almost full range to measure the change in capacitance caused by a touch. Thus, instead of having a range of 500-1024 to represent a touch, with baseline compensation through the voltage divider, the range is increased to 100-1024 to represent a touch. Thus, almost the entire full scale range is available for touch detection. In typical embodiments, the ΣΔ ADC has a range, e.g., of 10-16 bits and the full-scale range is determined both by the ΣΔ ADC and by the digital filters (see filter 924 in FIGS. 9A and 9B) that are applied to the output of the ΣΔ ADC.

To set the desired baseline, the clocks for the switched capacitor circuits and C_{VDIV} are adjusted until the ΣΔ ADC codes read the desired value, e.g., 100. In one embodiment, by setting the equivalent resistance R_{PAD} to be approximately equal to the compensation equivalent resistance R_{VDIV} allows most of the full range of the ΣΔ ADC to be used for touch detection. The particular setting for the voltage divider will be set according to the needs of the particular application and the range desired. Once the desired output of the ΣΔ ADC is reached by adjusting the frequency and/or capacitance parameters, those parameter values become the baseline for the capacitive touch sensor. A touch is then detected as a change above the baseline. For an expected negative excursion of the detected capacitance, the baseline is set high and a touch is then detected as a change below the baseline. Thus, when a negative excursion is expected the baseline compensation yields a code near full-scale value and the touch results in a lower code value (as the final result) and potentially a very low value. For mutual capacitance mode a negative excursion is expected and thus the baseline is set towards the top of the full scale range. However, in mutual capacitance mode there are a number of parasitic capacitors (to ground and across the pad) that affect the overall result and it can be difficult to predict whether a touch will result a positive or negative excursion from the baseline. To deal with that uncertainty, the baseline compensation can be determined empirically by setting the baseline compensation with the capacitive touch sensor mounted on the printed circuit board either during manufacturing or in the field. Once the frequency and/or capacitance parameters have been selected to obtain the desired baseline, they can be stored in non-volatile memory in the device for each pad, pin, and mode combination or a subset of desired pad, pin, and mode combinations. For example, the parameters can be determined for self-capacitance mode, mutual capacitance mode, and/or driven shield mode according to the needs of the system. The capacitance/frequency parameters can be determined during product test and saved at that time, on power up one or more times in the field, responsive to an environment change such as temperature change, and/or at any time appropriate for the particular application. Note that the model for the front end is the same for self capacitance mode and mutual capacitance mode.

FIG. 8 illustrates the capacitance sensing system 800 when a touch occurs. FIG. 8 shows the baseline compensation voltage divider formed by the equivalent resistances R_{PAD} 702 and R_{VDIV} 704. The presence of a touch results in an equivalent resistance R_{TOUCH} 804. The resistance R_{ΣΔ} 806 represents the ΣΔ ADC actively opposing the increased voltage resulting from R_{TOUCH} 804. The pulse density of the ΣΔ ADC increases to match the change resulting from the touch such that R_{ΣΔ}=R_{TOUCH}. The pulse density from the ΣΔ ADC increases to indicate how much work has to be done to oppose the presence of R_{TOUCH}. In an embodiment the ΣΔ ADC functions to bias the FE_OUT node to half of V_{REF} and the increase in pulse density indicates how much work is done to achieve that bias point. The ΣΔ ADC utilizes a reference threshold that is typically at the midpoint of the supply voltage to provide maximum deviation in both directions for internal analog signals and that reference threshold determines the appropriate bias point. The feedback mechanism to achieve that bias point is explained further herein.

While FIGS. 6-8 illustrate a solution that utilizes baseline compensation with a ΣΔ ADC coupled to the switched capacitor voltage divider front end, other embodiments provide baseline compensation to compensate for the static sensor baseline capacitance along with any static parasitic capacitance present using the switched capacitor voltage divider front end and ADCs other than a ΣΔ ADC coupled to the front end.

The front end (see 202, 302, 502) with baseline compensation can be used to determine capacitance in a low resolution manner. With reference to FIGS. 2, 3, and 5, in an embodiment, the clocks (CLKS_{EXT} (219) and/or CLKS_{VDIV} (223)) along with the capacitance C_{VDIV} (224) are adjusted until FE_OUT is at some midpoint threshold and the effective resistances 702 and 704 are the same. That allows the external capacitance value to be determined (assuming the internal capacitance C_{VDIV} is known). When a touch occurs, the voltage change detected with an ADC (not limited to ΣΔ ADCs) coupled to the front end (202, 302, 502), allows determination of the capacitance “change” caused the touch since all the other capacitances are known. The ADC could be, e.g., a successive approximation register (SAR) ADC or other ADC. That enables use of the front end coupled to an ADC as a capacitance touch sensor but with lower resolution than the ΣΔ ADC embodiments described herein.

Referring again to FIGS. 2 and 3, the first order ΣΔ ADC 204 of the illustrated embodiment includes the comparator 232, the flip-flop 234 sampling the output of the comparator at the sample rate of CLK_{ΣΔ} 236. While that approach can effectively utilize the switched capacitor front end, the integration capacitor C_{INT} is required. That capacitor should be large enough to prevent large voltage deviations from occurring during large C_{EXT} (C_{PAD}+C_{TOUCH}) charge transfers. Thus, in embodiments C_{INT} is approximately ten times C_{EXT} or more, e.g., 500 pF to 2 nF. A capacitor of that size is typically placed on the printed circuit board as the capacitance is too large for most applications to be placed in an integrated circuit. Placing C_{INT} on the printed circuit board requires another input/output terminal on the integrated circuit and space on the PCB. That adds cost.

FIG. 9A illustrates an embodiment that eliminates the need for the external integration capacitance C_{INT} and provides other advantages described herein. FIG. 9A shows a first stage 902 and a second stage 906 of a second order ΣΔ ADC 900. The first stage 902 includes a first integrator 904, which is implemented using a capacitance multiplier circuit. The capacitance multiplier circuit functions both as the integrating capacitor for charge transfer from the switched capacitor front end 202 (or 302, 502) and as a first integrator in the second order ΣΔ ADC 900. The second stage 906 of the ΣΔ ADC 900 includes a second integrator 908, which is a high-gain integrator that provides the second order integration for ΣΔ ADC 900. The ΣΔ ADC 900 further includes a comparator 910 and a flip-flop 912 that samples the output of the comparator at a sample rate determined by the frequency of the sample clock 911 (CLK_{ΣΔ}). The output comparator creates the output data stream for the ΣΔ ADC 900. The ΣΔ ADC may use ternary or other multi-level modulation implementations rather than a binary implementation and thus use multiple comparators to create the output data stream. Flip-flop 912 supplies the sampled output as data out (Dout) 914, which is fed back to the first and second stages through digital-to-analog converter (DAC) 916. With a ternary implementation Dout is two bits (3-levels) and the analog side of the DAC 916 has multiple levels of feedback voltage. The digital filter 924 converts the pulse density modulated output to decimated digital codes. The digital filter may be, e.g. a cascaded integrator comb (CIC) filter, an infinite impulse response filter (IIR), an averaging filter, in various combinations.

Dout is fed back to the first stage as an analog signal after being converted in the digital to analog converter 916. The DAC 916 generates the analog feedback signal as a voltage level based on the digital output signal Dout such that the feedback is negative. In the illustrated embodiment, the first stage uses a switched capacitor circuit 917 to provide an equivalent resistance in the feedback path to the first integrator 904. The switched capacitor circuit 917 in the first stage 902 is implemented with switches 918 and 920 and the variable feedback capacitance C_{FB1}. The non-overlapping clock signals supplied to the switches is based on CLK_{ΣΔ}. The variable capacitance allows the resistance setting to be tuned. The switched capacitor circuit 917 helps the ΣΔ ADC 900 track FE_OUT from the switched capacitor voltage divider front end 202.

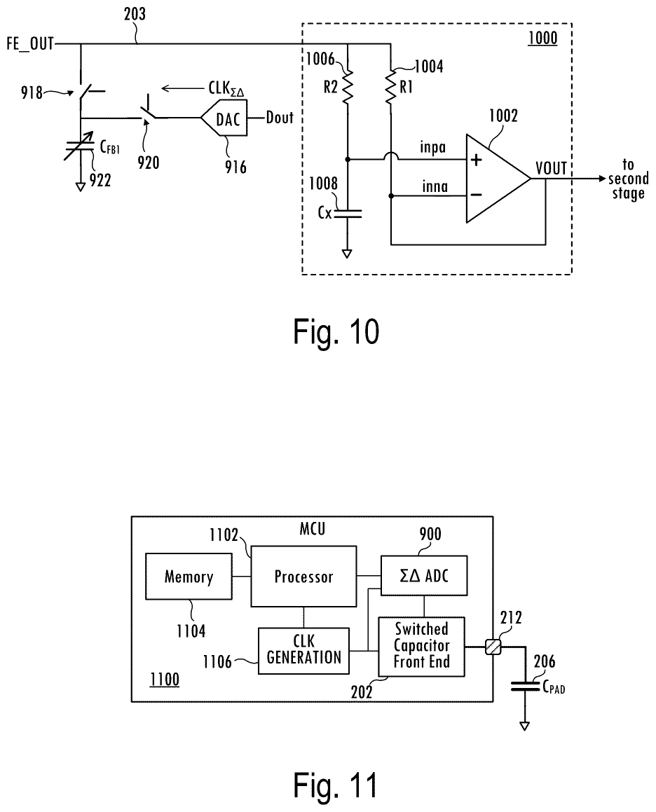

FIG. 10 illustrates an embodiment of a capacitance multiplier circuit 1000 used as the integrator 904. The capacitance multiplier circuit includes the amplifier 1002, resistor 1004 (R1), resistor 1006 (R2), and capacitance Cx 1008. Capacitance Cx may be implemented as a variable capacitance. The effective capacitance is determined as C_{EFF}CxxR2/R1. Thus, the effective capacitance is set by setting the ratio R2/R1 to the desired value along with the capacitance value of Cx. A high ratio R2/R1 allows a small capacitance on an integrated circuit to be effectively multiplied to be significantly larger and replace a larger capacitor on the PCB. The use of the capacitance multiplier circuit saves an I/O terminal on the integrated circuit and an external capacitor on the printed circuit board. FIG. 10 further shows the output Dout of the ΣΔ ADC being fed back through the switched capacitor circuit formed by switches 918 and 920 and capacitance 922 to the input of the capacitance multiplier circuit 1000. The capacitance multiplier circuit 1000 serves both as a low frequency integrator for the switched capacitor voltage divider front end 202 as well as a forward integrator for the ΣΔ ADC 900.

Referring back to FIG. 9A, the first stage 902 of the ΣΔ ADC maintains the front end voltage (FE_OUT) at the desired voltage divider threshold. Responsive to a touch, the Dout pulse density stream of the ΣΔ ADC increases, which increases the feedback to FE_OUT 203 through the equivalent resistance of switched capacitor circuit 917 to oppose the increase in voltage caused by the touch as represented by R_{A}F 806 in FIG. 8. Note that in the illustrated embodiment the first stage 902 of the ΣΔ ADC 900 has unity gain.

The second stage 906 of the ΣΔ ADC in the illustrated embodiment uses a variable capacitance for integrator 908. In addition, a switched capacitor circuit 930 provides an equivalent resistance between the first stage 902 and the second stage 906. Switches 932 and 934 and forward gain capacitance 936 (C_{FG}) form the switched capacitor circuit 930. In an embodiment, the switched capacitor circuit 930 is clocked by the sample clock 911 (CLK_{ΣΔ}).

The second stage 906 of the ΣΔ ADC further includes a switched capacitor circuit 940 that provides an equivalent resistance in the feedback path of Dout to the second stage. Switches 942 and 944 and capacitance 946 (C_{FB2}) form the feedback switched capacitor circuit 940. The second stage works with the first stage to set the sensitivity and range of the ΣΔ ADC. The use of the switched capacitor circuit 940 allows both programmability of the resistance value by varying the capacitance C_{FB2} and/or the sampling clock frequency. In addition, in embodiments, as mentioned previously, the second integrator 908 capacitance is programmable. The use of the switched capacitor circuit 940, which can be implemented on the integrated circuit, makes the use of an off-chip resistor unnecessary. The gain of the second stage can be programmed by setting the equivalent resistances provided by switched capacitor circuits 930 and 940 to desired values. In typical feedback implementations, one or more of the resistances provided by switched capacitor circuits 930 and 940 are implemented using off-chip resistors. That limits programmability. Remember that nearly the full range of the ΣΔ ADC is available for touch sensing due to the baseline compensation using baseline compensation voltage divide R_{PAD} and R_{VDIV} (see FIG. 8). That means the second stage 903 of the ΣΔ ADC should be set to high gain to exploit the use of the nearly full range available for touch sensing. Having programmability for switched capacitor circuits 930 and 940 allows the gain of the ΣΔ ADC to be internally tuned, i.e., tuned inside the integrated circuit to a desired value. That approach removes the need for a precision external gain setting feedback resistor.

FIG. 9B illustrates an embodiment of a second order ΣΔ ADC 950 in which the switched capacitor circuits 917, 930, and 940 are replaced by resistors 952, 954, and 956 while the other components of the ΣΔ ADC 950 are the same as the components of the ΣΔ ADC 900 including the use of a capacitance multiplier circuit for the first integrator and the switched capacitor front end 202. In other embodiments only some of the switched capacitor circuits 917, 930, and 940 are replaced by resistors.

FIG. 11 illustrates a high level block diagram of an embodiment of a microcontroller unit (MCU) 1100 that incorporates one or more embodiments of a capacitor touch sensor described herein. The MCU 1100 includes one or more processors 1102 and memory 1104. The memory stores programs and data for use by the processor(s) 1102. The processor(s) 1102 may implement the digital filter 924 (FIG. 2) and control aspects for setting the baseline (adjusting clock/capacitance parameters until a desired ΣΔ ADC output is achieved) and detecting a touch. Memory 1104 may include volatile memory, including static random access memory (SRAM) and dynamic random access memory (DRAM), non-volatile memory (NVM), and other memory such as registers suitable for the particular application. For example, NVM memory may be used to store baseline frequency and capacitance parameters. In addition, the processor 1102 or other digital logic may be used to determine after the digital filtering, whether the detected change in capacitance was sufficiently above the baseline to be considered a touch. The MCU 1100 further includes clock generation logic 1106 to supply the various clocks required by the switched capacitor front end 202, 302, and/or 502 and the ΣΔ ADC 900. The processor 1102 or other logic may also be used to set the gain in the ΣΔ ADC 900. The MCU 1100 includes the I/O terminal 212 for the pad capacitance C_{PAD} 206. Of course, mutual capacitance mode will require an additional I/O terminal 212.

Thus, techniques for capacitive sensing have been described. The description of the invention set forth herein is illustrative and is not intended to limit the scope of the invention as set forth in the following claims. The terms “first,” “second,” “third,” and so forth, as used in the claims, unless otherwise clear by context, are to distinguish between different items in the claims and do not otherwise indicate or imply any order in time, location or quality. Variations and modifications of the embodiments disclosed herein may be made based on the description set forth herein, without departing from the scope of the invention as set forth in the following claims.

1. A capacitance touch sensor comprising:
a first effective resistance formed with a sensor capacitance configured in a first switched capacitor circuit;
a baseline compensating effective resistance formed with a compensation capacitance configured in a second switched capacitor circuit;
wherein the first effective resistance and the baseline compensating effective resistance form an effective voltage divider;
an analog to digital converter coupled to the effective voltage divider and configured to supply an indication of a capacitance sensed by the capacitive touch sensor; and
wherein the compensation capacitance is formed in an integrated circuit and the sensor capacitance is disposed outside of the integrated circuit.

2. (canceled)

3. The capacitance touch sensor as recited in claim 1,
wherein the first effective resistance is coupled between a first power supply node and a first node; and
wherein the baseline compensating effective resistance is coupled between the first node and a second power supply node.

4. The capacitance touch sensor as recited in claim 3 wherein the first effective resistance comprises:
a first switch coupled between the first power supply node and the first node;
a second switch coupled between the first node and a second node, the second node coupled to the analog to digital converter;
wherein the first and second switches are coupled to first and second clock signals having a first frequency; and
wherein a first electrode of the sensor capacitance is coupled to the first power supply node through the first switch.

5. The capacitance touch sensor as recited in claim 4 wherein a second electrode of the sensor capacitance is coupled to ground.

6. The capacitance touch sensor as recited in claim 4 wherein the baseline compensating effective resistance comprises:
a third switch coupled between the second node and the compensation capacitance;
a fourth switch coupled in parallel with the compensation capacitance;
wherein the compensation capacitance is coupled between the third switch and ground; and
wherein the third switch and the fourth switch are coupled respectively to a third clock signal and a fourth clock signal, the third clock signal and the fourth clock signal having a second frequency, the second frequency being higher than the first frequency.

7. The capacitance touch sensor as recited in claim 4 further comprising:
a fifth switch coupled between the first power supply node and a second electrode of the sensor capacitance;
a sixth switch coupled between the second electrode and ground; and
wherein the fifth switch and the sixth switch are coupled respectively to a fifth clock signal and a sixth clock signal, both the fifth clock signal and the sixth clock signal having the first frequency.

8. The capacitance touch sensor as recited in claim 1 wherein the analog to digital converter is a sigma delta analog to digital converter.

9. The capacitance touch sensor as recited in claim 6 wherein one or more of the compensation capacitance, the first frequency, and the second frequency are programmable and one or more of the compensation capacitance, the first frequency, and the second frequency are adjusted to achieve a desired output of the analog to digital converter as a baseline value.

10. The capacitance touch sensor as recited in claim 9 further comprising a memory to store a value corresponding to the compensation capacitance, the first frequency, and the second frequency that achieve the baseline value.

11. A method for sensing a capacitance with a capacitive touch sensor comprising:
generating a first effective resistance using a first switch and a second switch and a sensor capacitance in a first switched capacitor circuit;
using first and second clock signals having a first frequency to respectively control the first and second switches;
generating a baseline compensating effective resistance using third and fourth switches and a compensation capacitance in a second switched capacitor circuit;
using third and fourth clock signals having a second frequency to respectively control the third and fourth switches, the second frequency being higher than the first frequency;
using the first effective resistance and the baseline compensating effective resistance as an effective voltage divider; and
supplying an output of the effective voltage divider indicative of a sensed capacitance to an analog to digital converter.

12. The method as recited in claim 11 further comprising generating a baseline output for the capacitive touch sensor by adjusting one or more of the first effective resistance and the baseline compensating effective resistance until an output of the analog to digital converter is at a desired value.

13. (canceled)

14. (canceled)

15. The method as recited in claim 11 further comprising, for operating in mutual capacitance mode or for operating in water droplet tolerance mode using fifth and sixth switches and fifth and sixth clock signals having the first frequency to respectively control the fifth and sixth switches.

16. The method as recited in claim 15 further comprising selectively coupling a first electrode of the sensor capacitance to a first power supply node at a first time using the first switch and to a second power supply node at a second time using the sixth switch.

17. The method as recited in claim 11 further comprising generating a baseline output for the capacitive touch sensor by adjusting one or more of the first frequency, the second frequency, and the compensation capacitance until an output of the analog to digital converter is at a desired value.

18. The method as recited in claim 11 further comprising:
increasing an available range of the analog to digital converter to indicate a touch on the capacitive touch sensor by using the effective voltage divider formed with the first effective resistance and the baseline compensating effective resistance.

19. (canceled)

20. (canceled)

21. The capacitance touch sensor as recited in claim 1,
wherein the first effective resistance includes a first switch and a second switch controlled by first non-overlapping clock signals having a first frequency; and
wherein the baseline compensating effective resistance includes a third switch and a fourth switch controlled by second non-overlapping clock signals having a second frequency, the second frequency being greater than the first frequency.

22. The capacitance touch sensor as recited in claim 21, wherein the second frequency is at least an order of magnitude greater than the first frequency.

23. The method as recited in claim 15 further comprising using the fifth and sixth switches when operating in water tolerance mode to equalize a voltage between a driven shield around the sensor capacitance and the sensor capacitance.

24. The method as recited in claim 15 further comprising configuring the capacitive touch sensor to operate in mutual capacitance mode, water droplet capacitance mode, or self-capacitance mode.

25. A capacitance touch sensor comprising:
a first effective resistance formed with a sensor capacitor configured in a first switched capacitor circuit;
a baseline compensating effective resistance formed with a compensation capacitor configured in a second switched capacitor circuit;
wherein the first effective resistance and the baseline compensating effective resistance form an effective voltage divider;
analog to digital converter coupled to the effective voltage divider and configured to supply an indication of a capacitance sensed by the capacitive touch sensor;
wherein the first effective resistance includes a first switch and a second switch controlled by first non-overlapping clock signals having a first frequency;
wherein the baseline compensating effective resistance includes a third switch and a fourth switch controlled by second non-overlapping clock signals having a second frequency, the second frequency being greater than the first frequency; and
wherein the compensation capacitor is smaller than the sensor capacitor.
